(19) United States
(12) Patent Application Publication
(10) Pub. No.: US 2003/0043139 A1
(43) Pub. Date: Mar. 6, 2003

(54) METHOD AND APPARATUS FOR AUTOMATIC DIGITAL DC BALANCING FOR AN IMAGER OF A DISPLAY

(76) Inventor: DAVID W. ENGLER, CYPRESS, TX (US)

Correspondence Address: FLESHNER & KIM, LLP, P.O.Box 221200, Chantilly,, VA, 20153-1200, US

(21) Appl. No.: 09/183,914

(22) Filed: Oct. 31, 1998

(51) Int. Cl. G09G 5/00

(52) U.S. Cl. 345/211

(57) ABSTRACT

A monitor provides automatic digital DC balancing for one or more imagers for a display of the monitor. The circuitry includes a filter for filtering one or more analog video signals, a microcontroller of the circuitry samples and digitizes the filtered analog video signal to generate a digital video signal. The microcontroller samples the filtered analog video signal for a portion of the display having known data values. The microcontroller then applies a digital filter to the digital video signal. The microcontroller detects a need for DC balancing by comparing the digital video signal in its upper operating range and its lower operating range with a digital reference DC signal corresponding to the DC signal level of the display. The circuitry further includes a digital potentiometer corresponding to each analog video signal. The microcontroller maintains DC balancing by providing a feedback signal to the digital potentiometers. When the analog video signal is not sufficiently DC balanced, the signal may be sufficiently DC balanced by adjusting an upper DC offset component or a lower DC offset component of the analog video signal. The microcontroller thus compensates on the fly for any drifting of analog drive circuitry providing the analog video signal.

### BACKGROUND OF THE INVENTION

1. Field of the Invention

The present invention relates to DC balancing for an imager, and more particularly to a method and apparatus for automatic digital DC balancing for an imager for a display.

2. Description of the Related Art

A variety of today's displays, such as a liquid crystal display (LCD), for example, have required a DC-balanced analog drive signal. A DC-balanced analog drive signal provided an average zero volt DC (direct current) change. If a non-zero volt DC change on average was applied to a LCD, the LCD over time degraded and eventually was destroyed. Video display applications thus frequently required DC balancing circuitry.

### SUMMARY OF THE INVENTION

Briefly, in accordance with the present invention, a monitor provides automatic digital DC balancing for one or more imagers for a display of the monitor. The circuitry includes a filter for filtering one or more analog video signals, and a microcontroller of the circuitry samples and digitizes the filtered analog video signal to generate a digital video signal. The microcontroller samples the filtered analog video signal for a portion of the display having known data values. The microcontroller then applies a digital filter to the digital video signal. The microcontroller detects a need for DC balancing by comparing the digital video signal in its upper operating range and its lower operating range with a digital reference DC signal corresponding to the DC signal level of the display.

The circuitry further includes a digital potentiometer corresponding to each analog video signal. The microcontroller maintains DC balancing by providing a feedback signal to the digital potentiometers. When the analog video signal is not sufficiently DC balanced, the signal may be sufficiently DC balanced by adjusting an upper DC offset component or a lower DC offset component of the analog video signal. The microcontroller thus compensates on the fly for any drifting of analog drive circuitry providing the analog video signal.

### BRIEF DESCRIPTION OF THE DRAWINGS

A better understanding of the present invention can be obtained when the following detailed description of the preferred embodiment is considered in conjunction with the following drawings, in which:

FIG. 1 is a simplified schematic diagram of a system including a host computer and monitor;

FIG. 2 is a schematic diagram of an exemplary video architecture of the monitor of FIG. 1 incorporating analog conditioning circuitry in accordance with the present invention;

FIG. 3 is a flow chart of an automatic digital DC balancing process in accordance with the present invention;

FIG. 4 is a schematic diagram of a portion of the video circuitry of FIG. 2 for accomplishing automatic video digital DC balancing in accordance with the present invention; and

FIG. 5 is an illustration of an analog video signal highlighting the portions of the signal sampled by the microcontroller of FIGS. 2 and 4 and a start frame signal in accordance with the present invention.

### DETAILED DESCRIPTION OF THE PREFERRED EMBODIMENT

The following patent application is hereby incorporated by reference as if set forth in its entirety:

Commonly-assigned and concurrently filed U.S. Patent Application, Attorney Docket No. A98070US, entitled “ANALOG CONDITIONING CIRCUITRY FOR IMAGERS FOR A DISPLAY.”

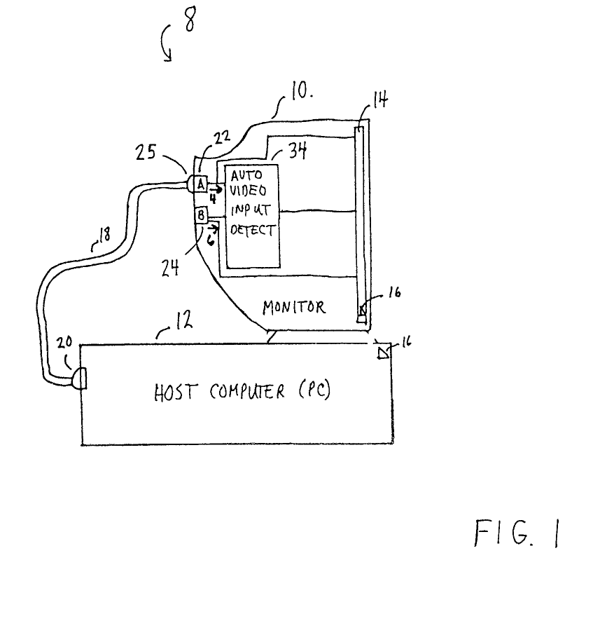

Turning now to the drawings, FIG. 1 shows a simplified schematic diagram of a system 8 including a host computer 10 and a video monitor 12. The host computer 10 includes a graphics card 11 for communicating video information (e.g. pixel information) from the host computer 10 to the monitor 12. The monitor 12 is preferably a high frequency monitor. Host systems other than the host computer system 10 may alternatively drive the monitor 12.

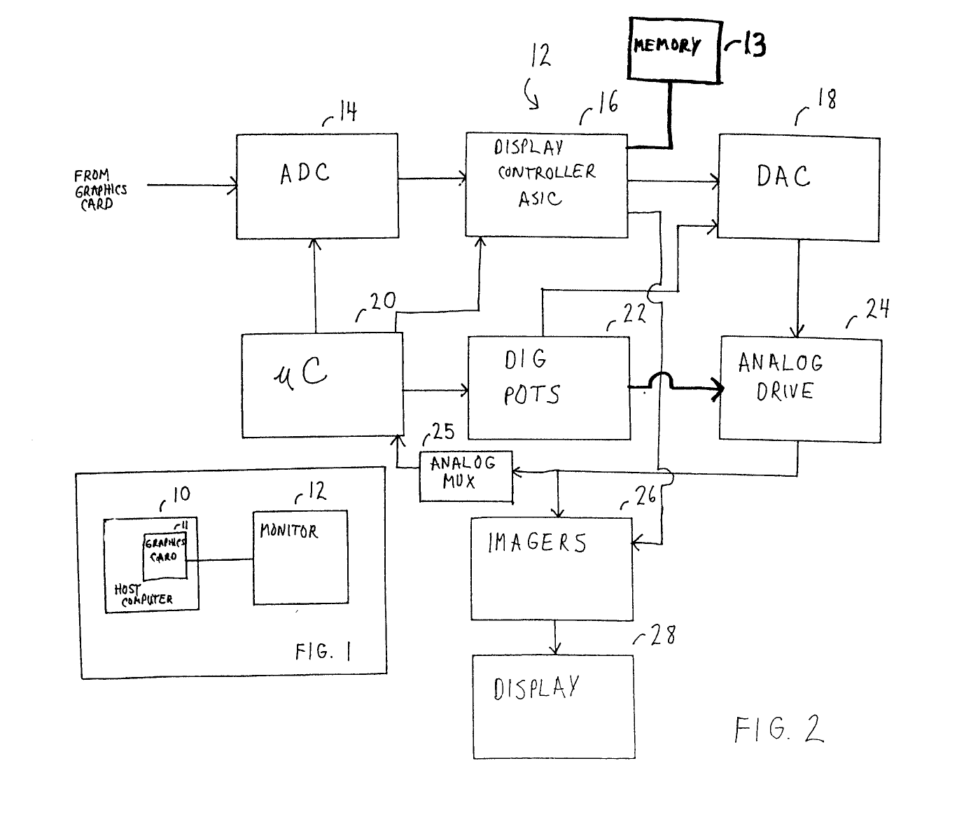

Referring to FIG. 2, a schematic diagram of an exemplary video architecture of the monitor 12 is shown. A video signal from the graphics card 11 of the host computer 10 is provided to an analog-to-digital converter (ADC) 14 which digitizes the video signal. In the disclosed embodiment, the analog-to-digital converter 14 is at least a 10-bit analog-to-digital converter providing 8 analog input channels. An example of a suitable analog-to-digital converter 14 is the “Paradise Bridge 120” available from Paradise Electronics.

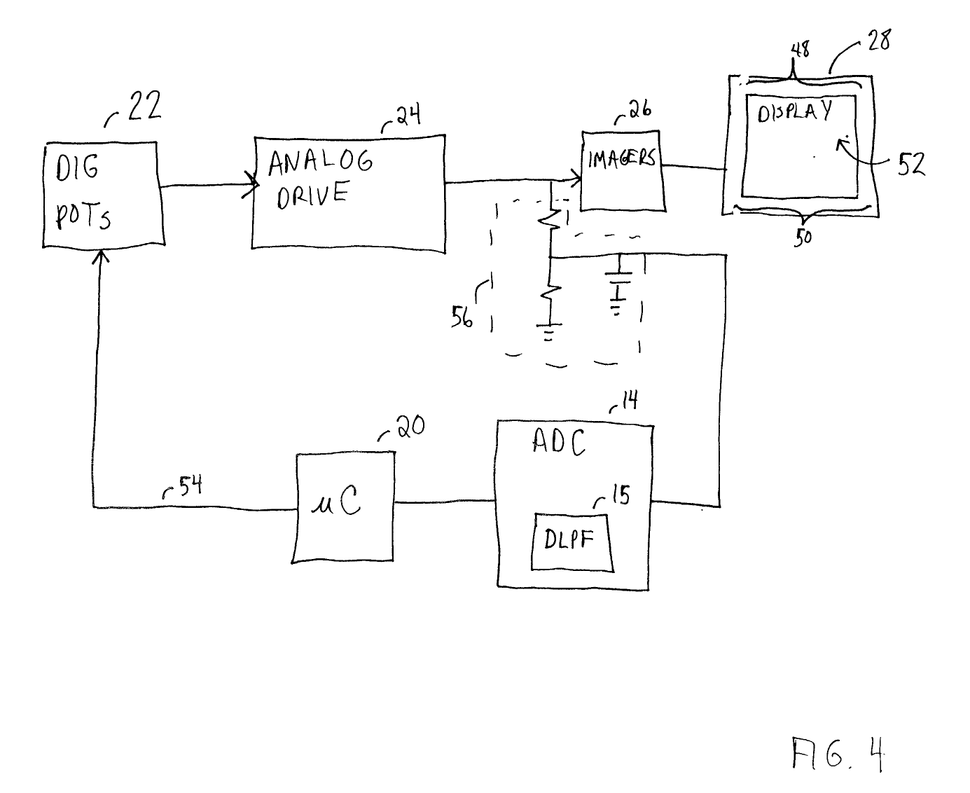

A display controller ASIC 16 receives the digitized video signal from the ADC 14. The display controller ASIC 16 is configured for processing (e.g., scaling or buffering) the digital video signal. The processed video signal is provided from the display controller ASIC 16 to a digital-to-analog converter (DAC) 18 (FIGS. 2 and 4). The DAC 18 converts the digital video signal to an analog video signal. In the disclosed embodiment, the DAC 18 is a 8-bit to 10-bit current output digital-to-analog converter. The DAC 18 is preferably capable of mapping at least 256 input levels. An example of a suitable DAC is the HI3050 available from Harris Semiconductor.

The ADC 14 is coupled to a microcontroller (μC) 20. The microcontroller 20 configures the ADC 14 for video data digital conversion. The microcontroller 20 is also responsible for configuring the display controller ASIC 16. An example of a suitable microcontroller is the 80C930HF microcontroller available from Intel Corporation.

The video architecture of the monitor 12 further includes a plurality of digital potentiometers (DIG POTs) 22 (FIGS. 2 and 4). The microcontroller 20 programs the DIG POTs 22 through a control signal. Each digital potentiometer 22 is basically a digitally controlled variable resistor. A resistance value of a digital potentiometer 22 is a function of a position of a wiper with respect to two endpoints. In the disclosed embodiment, each digital potentiometer 22 provides at least 256 positions (or contact points). An example of a suitable digital potentiometer chipset is the AD8403 available from Analog Devices, Inc. A digital signal reflecting the resistance value of the digital potentiometer 22 is provided to the DAC 18.

The DAC 18 provides an analog signal to analog drive circuitry 24 (FIGS. 2, 4 and 6). The analog drive circuitry 24 provides a plurality of analog drive signals to one or more imagers or light valves 26. The imagers 26 receive clocking and configuration signals from the display controller ASIC 16. The imagers 26 are preferably refreshed at a minimum scanning frequency of 60 hertz. An imager 26 essentially converts light intensity modulation information contained in an analog drive signal to light energy emitted to a display 28. The display 28 may take the form of a variety of display types. In the disclosed embodiment, the display 28 is a liquid crystal display (LCD). The analog drive circuitry 24 also provides the plurality of analog video signals through an analog multiplexer 25 to the microcontroller 20.

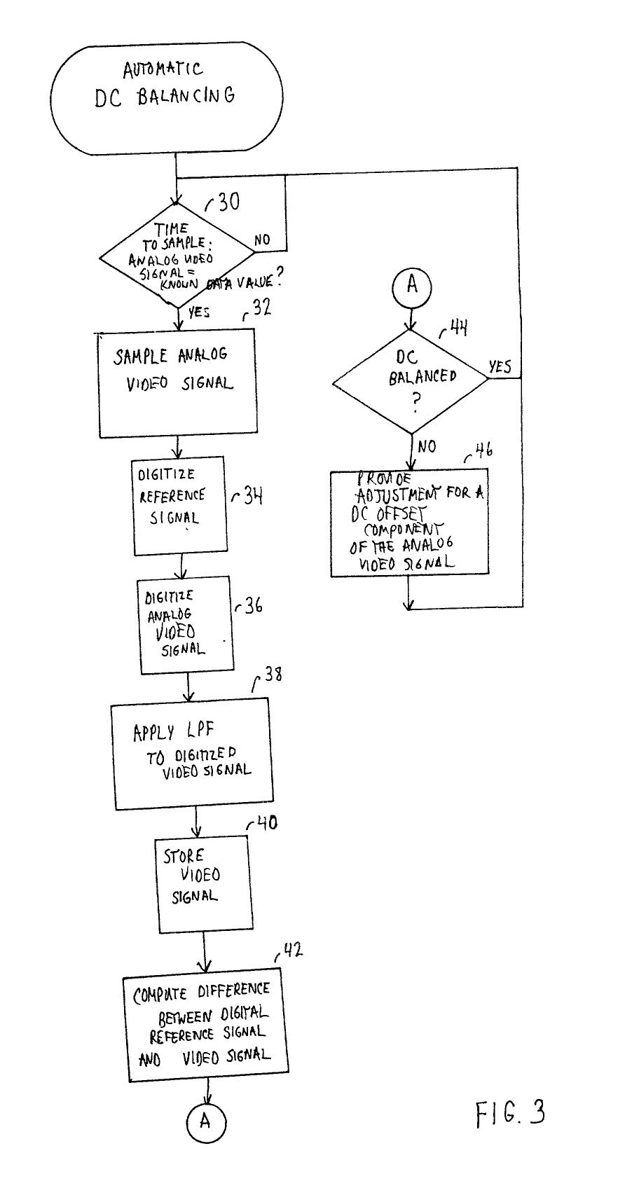

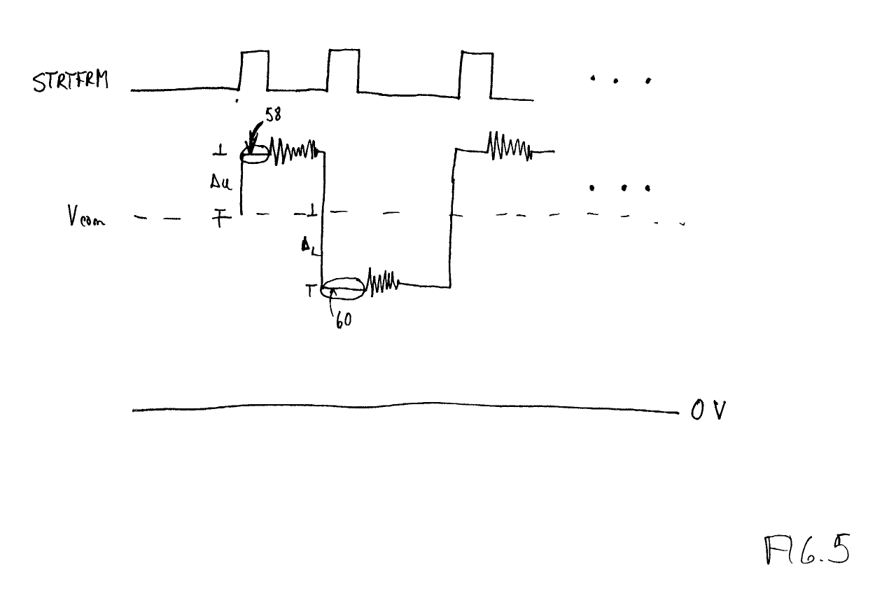

Referring to FIG. 3, a flow chart of an automatic DC balancing process in accordance with the present invention is shown. Beginning in step 30, it is determined if it is time to sample an analog video signal. The analog video signal should be sampled at a portion of the display 28 having known data values. An example of a predetermined condition for determining when to sample an analog video signal is when the analog video signal must correspond to a full scale color (e.g., black). In the disclosed embodiment, the analog video signal is preferably sampled at a top border region 48 of the display 28. In certain displays, the top border region 48 is known to be black. Referring to FIG. 5, by utilizing a start frame signal STRTFRM, it can be determined whether an analog video signal is driving the top border region 48. The analog video signal is shown with respect to the reference DC signal V_{com}. When the analog video signal includes its upper DC offset component, the analog video signal is above the reference DC signal V_{com}. When the analog video signal includes its lower offset component, the analog video signal is below the reference DC signal V_{com}. A signal portion 58 of the analog video signal corresponds to the signal driving the top border region 48. The microcontroller 20 knows when to sample the analog video signal by detecting a falling or rising edge of the start frame signal STRTFRM. As illustrated, the rising edge of the start frame signal STRTFRM indicates when the analog video signal begins to drive the top border region 48. A signal portion 60 of the analog video signal corresponds to the signal driving the bottom border region 50. The microcontroller 20 alternatively could sample the analog video signal an appropriate number of lines after an assertion or deassertion of the start frame signal when the video signal is driving the bottom border region 50.

If it is determined in step 30 that it is not time to sample, then control remains at step 30. If it is determined in step 30 that it is time to sample the analog video signal, then control proceeds to step 32 where the analog video signal is sampled. Next, in step 34, a reference DC signal V_{com} corresponding to the DC level of the display 28 is digitized. Conversion of the reference DC signal V_{com} to a digital form may be performed by the ADC 14. From step 34, control passes step 36 where the analog video signal is digitized by the ADC 14. A digital low pass filter 15 is then applied to the digitized video signal to minimize noise in step 38. Control next proceeds to step 40 where the digital drive signal value is stored. In the disclosed embodiment, a plurality of digital video signal values may be stored in a shifting array. As each new digital drive signal value is stored in the shifting array, the previous digital video signal values are shifted to adjacent array locations. The digital video signal value stored in the last array location is, in effect, deleted.

From step 40, control proceeds to step 42 where the difference between the digital reference signal value and the stored digital video signal value is computed. This difference may be positive or negative depending upon whether the digital reference signal value is greater or less in value than the digital video signal value.

Next, in step 44, it is determined if the digital video signal reflects a DC balanced digital video signal. DC balance error is present if the difference between the digital video signal in its upper operating range and the reference DC signal V_{com} in its upper operating range and the reference DC signal V_{com} is significantly different from the magnitude of the difference between the digital video signal in its lower operating range and the reference DC video signal V_{com}. If the magnitude of these differences is the same or differs within a predetermined offset, then the analog video signal is DC balanced. If there is DC balance error, then the digital video signal is not DC balanced. If there is no DC balance error, then the digital video signal is DC balanced. If it is determined in step 44 that the video signal is DC balanced, then control returns to step 30. If it is determined in step 44 that the video signal is not DC balanced, then control proceeds to step 46. In step 46, the microcontroller 20 provides a feedback signal 54 to the DIG POTs 22 to adjust a DC offset component of the analog video signal. This adjustment may be to the upper DC offset component or the lower DC offset component of the analog video signal. Δ_{U} represents a difference between an analog video signal in its upper operating range and the reference DC signal V_{com}. Δ_{L} represents a difference between the analog video signal in its lower operating range and the reference DC signal V_{com}. If Δ_{U} is significantly greater than Δ_{L}, then an adjustment to increase the upper DC offset component may be generated. If Δ_{U} is significantly less than Δ_{L}, then an adjustment to increase the lower DC offset component may be generated. This adjustment is a function of the difference between the digital reference signal and the digital video signal. The feedback signal 54 ensures that a DC-balanced analog drive signal is provided to the imagers 26. The digital drive feedback signal DC balances the analog video signal. The adjustment to the feedback signal 54 is programmed by the microcontroller 20 based on the difference between the digitized reference DC signal V_{com} and the digital video signal. This rebalancing operation, which may only take a few hundred milliseconds, is preferably performed during a period of time when a user will not notice the rebalancing. From step 46, control returns to step 30. The automatic DC balancing process is essentially a continuous process of DC balancing. In this way, any drift in the analog drive circuitry 24 is effectively countered. The automatic DC balancing process may be applied to a plurality of analog video signals.

It should be understood that other ways of accomplishing automatic DC balancing in a digital domain are possible. It should further be understood that other ways of utilizing a microcontroller and a digital potentiometer to accomplish DC balancing are possible. Also, other ways of accomplishing automatic DC balancing through software are possible.

The foregoing disclosure and description of the invention are illustrative and explanatory thereof, and various changes in the variables, parameters, steps, fields, data types, code elements, components, circuit elements, wiring connections and contacts, as well as in the details of the illustrated hardware and software and construction and method of operation may be made without departing from the spirit of the invention.

We claim:

1. A method of automatic digital DC balancing of an analog video signal for at least one imager of a display, comprising the steps of:
sampling an analog video signal;
digitizing the analog video signal to generate a digital video signal; and
providing a feedback signal to balance the analog video signal if the digital video signal indicates the analog video signal is not DC balanced.

2. The method of claim 1, further comprising the step of:
digitizing a reference DC signal to generate a digital reference DC signal.

3. The method of claim 2, wherein the reference DC signal corresponds to the DC signal level of the display.

4. The method of claim 2, further comprising the step of:
comparing the digital video signal with the digital reference DC signal.

5. The method of claim 4, the comprising step further comprising the step of:
comparing the digital video signal in its upper operating range with the digital reference DC signal;
comparing the digital video signal in its lower operating range with the digital reference DC signal; and
comparing the difference between the digital video signal in its upper operating range and the digital reference DC signal and a difference between the digital video signal in its lower operating range and the digital reference DC signal.

6. The method of claim 1, further comprising the step of:
digitally low pass filtering the digital video signal.

7. The method of claim 1, further comprising the step of:
detecting when to sample the analog video signal.

8. The method of claim 1, wherein the analog video signal is sampled when the analog video signal is driving a known data value to the display.

9. The method of claim 1, wherein the analog video signal is sampled when the analog video signal is driving a top border region of the display.

10. The method of claim 1, further comprising the step of:
low pass filtering the analog video signal.

11. An automatic digital DC balancing circuit for at least one imager of a display, comprising:
a microcontroller for sampling an analog video signal and for controlling DC balancing of the analog video signal based on a digital video signal corresponding to the analog video signal; and
an analog to digital converter for converting the analog video signal to the digital video signal.

12. The balancing circuit of claim 11, the analog to digital converter comprising:
a digital low pass filter for filtering the digital video signal.

13. The balancing circuit of claim 11, further comprising:
at least one digital potentiometer for receiving a feedback signal from the microcontroller to maintain DC balancing of the analog video signal.

14. The balancing circuit of claim 11, the microcontroller executing code for performing steps comprising:
comparing the digital video signal with the digital reference DC signal.

15. An automatic digital DC balancing circuit for at least one imager of a display, comprising:
a means for sampling an analog video signal; and
a means for controlling DC balancing of the analog video signal based on a digital video signal corresponding to the analog video signal.

16. The balancing circuit of claim 15, further comprising:
a means for adjusting a feedback signal for maintaining DC balancing of the analog video signal.

17. The balancing circuit of claim 15, further comprising:
a means for digitizing the analog video signal to generate a digital video signal;
a means for digitizing a reference DC signal to generate a digital reference DC signal; and
a comparing means for comparing the digital video signal with the digital reference DC signal.

18. The balancing circuit of claim 16, the comparing comprising:
a comparing means for comparing the digital video signal in its upper operating range with the digital reference DC signal;
a comparing means for comparing the digital video signal in its lower operating range with the digital reference DC signal; and
a comparing means for comparing a difference between the digital video signal in its upper operating range and the digital reference DC signal with the digital video signal in its lower operating range and the digital reference DC signal.

19. The balancing circuit of claim 14, further comprising:
a means for digitally low pass filtering the digital video signal.
